(19) United States
(12) Patent Application Publication
(10) Pub. No.: US 2013/0249856 A1
(43) Pub. Date: Sep. 26, 2013

(54) TOUCH DEVICE AND TOUCH SENSING METHOD THEREOF

(71) Applicants: Dongguan Masstop Liquid Crystal Display Co., Ltd., Dongguan City (CN); WINTEK CORPORATION, Taichung City (TW)

(72) Inventors: Ching-Fu Hsu, Taichung City (TW); Chong-Wei Li, Changhua County (TW); Yu-Hung Chang, Miaoli County (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/794,810

(22) Filed: Mar. 12, 2013

(30) Foreign Application Priority Data
Mar. 12, 2012 (TW) 101108306

(51) Int. Cl. G06F 3/041

(52) U.S. Cl. CPC G06F 3/041
USPC 345/174; 345/173

(57) ABSTRACT

A touch device, having a touch sensing region, includes a touch sensing structure and at least one object detecting device. The touch sensing structure is disposed in the touch sensing region. The touch sensing region is divided into a plurality of sub sensing regions, and the touch structure includes a plurality of sensing units for providing a function of positioning touch points. The object detecting device is disposed outside the touch sensing region. The object detecting device is employed to detect whether an object getting is close to the touch device and to determine which one of the sub sensing regions is going to be touched by the object so as to further enable the sensing units within the sub sensing region that is going to be touched by the object.

### BACKGROUND OF THE INVENTION

1. Field of the Invention

The present invention relates to a touch device and a touch sensing method of the touch device, and more particularly to a touch device including an object detecting device disposed outside a touch sensing region, and a touch sensing method of the touch device.

2. Description of the Prior Art

Recently, touch panels are widely applied in the consumer electronic products, and various touch sensing methods are utilized in the touch panels. The capacitive touch panel has the advantages of high accuracy, multi-touch function and high touch resolution; which is why the capacitive touch panel is now prominently used in the field of touch technologies.

In the conventional capacitive touch panel, two sets of axis sensing units crossed and arranged along different axes are disposed inside. As the scanning method of the touch sensing method is performed, driving signals provided by the controller integrated circuit (controller IC) are delivered to a set of axis sensing units, and another set of axis sensing units is used to sense and obtain the detecting signals. Furthermore, the variations of the detecting signals are calculated to determine the position of touch point. Accordingly, the number of the axis sensing units positively relates to the touch resolution, in other words, increasing the number of the axis sensing units can improve the touch resolution. Conversely, increasing the number of the axis sensing units to be controlled and enabled may require more power for the controller IC, and increase the cost of the controller IC and the overall electricity dissipation. Similarly, to sustain the equivalent touch resolution for the large size touch panels, the number of the axis sensing units increase with the enlargement of touch panel size, thereby increasing the power consumption of the controller IC and deteriorating the report rate and not meeting the requirements; in this way the touch sensing efficiency is further adversely affected.

### SUMMARY OF THE INVENTION

An objective of the present invention is therefore to provide a touch device and a touch sensing method of the touch device. The touch device includes an object detecting device disposed outside a touch sensing region to detect the movement of the external objects and determine which part of the touch sensing region may be touched in advance, and deciding if the touch sensing structure in the touch sensing region should be enabled. Furthermore, the method of partially turning on the touch sensing structure can lower down the power consumption for driving the controller IC and increase the report rate of the touch device.

According to one exemplary embodiment of the present invention, a touch device having a touch sensing region is provided. The touch device includes a touch sensing structure and at least one object detecting device. The touch sensing structure is disposed in the touch sensing region of the touch device. The touch sensing region is divided into a plurality of sub sensing regions, and includes a plurality of sensing units for providing a function of positioning touch points. The object detecting device is disposed outside the touch sensing region, and the object detecting device is employed to detect whether an object is getting close to the touch device and determine which one of the sub sensing regions is going to be touched by said object, in order to further enable the sensing units within the enabled sub sensing region that is going to be touched by the object.

According to another exemplary embodiment of the present invention, a touch sensing method of a touch device includes the following steps. First, a touch device having a touch sensing region is provided. The touch device includes a touch sensing structure and at least one object detecting device. The touch sensing region of the touch device is divided into a plurality of sub sensing regions, and the touch sensing structure includes a plurality of sensing units for providing a function of positioning touch points. The object detecting device is disposed outside the touch sensing region. Subsequently, if an object getting close to the touch device is detected by the object detecting device. Furthermore, the sub sensing region that is going to be touched by the object is determined with the object detecting device, and the sensing units within the enabled sub sensing region which is going to be touched by the object are enabled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch device according to the first exemplary embodiment of the present invention.

FIG. 2 is a three-dimensional schematic diagram illustrating an operation of a touch device according to the first exemplary embodiment of the present invention.

FIG. 3 is a flow chart illustrating a touch sensing method of a touch device according to the first exemplary embodiment of the present invention.

FIG. 4 is a schematic diagram illustrating the signal delivering pathway of a touch device according to the first exemplary embodiment of the present invention.

FIG. 5 is a flow chart illustrating a touch sensing method of a touch device according to another exemplary embodiment of the present invention.

FIG. 6 is a flow chart illustrating a touch sensing method of a touch device according to the other exemplary embodiment of the present invention.

FIG. 7 is a schematic diagram illustrating a touch device according to the second exemplary embodiment of the present invention.

FIG. 8 is a three-dimensional schematic diagram illustrating an operation of a touch device according to the second exemplary embodiment of the present invention.

FIG. 9 is a schematic diagram illustrating a touch device according to the third exemplary embodiment of the present invention.

FIG. 10 is a schematic diagram illustrating a touch device according to the fourth exemplary embodiment of the present invention.

FIG. 11 is a schematic diagram illustrating a touch device according to the fifth exemplary embodiment of the present invention.

### DETAILED DESCRIPTION

To provide a better understanding of the present invention, preferred exemplary embodiments will be described in detail herein. The preferred exemplary embodiments of the present invention are illustrated in the accompanying drawings with numbered elements.

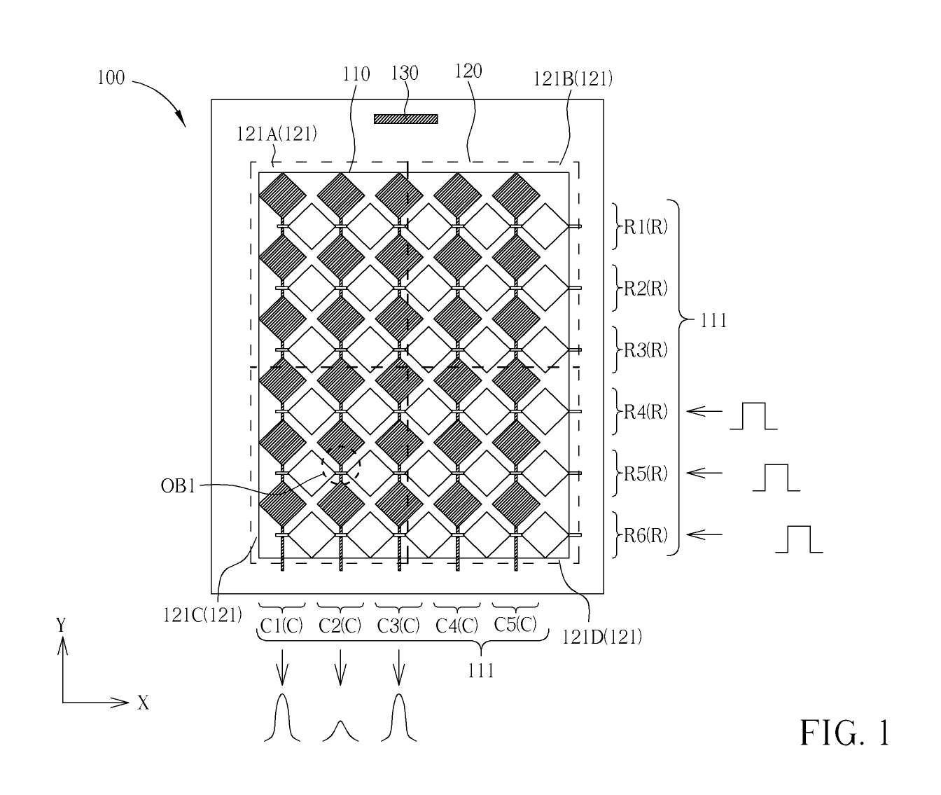

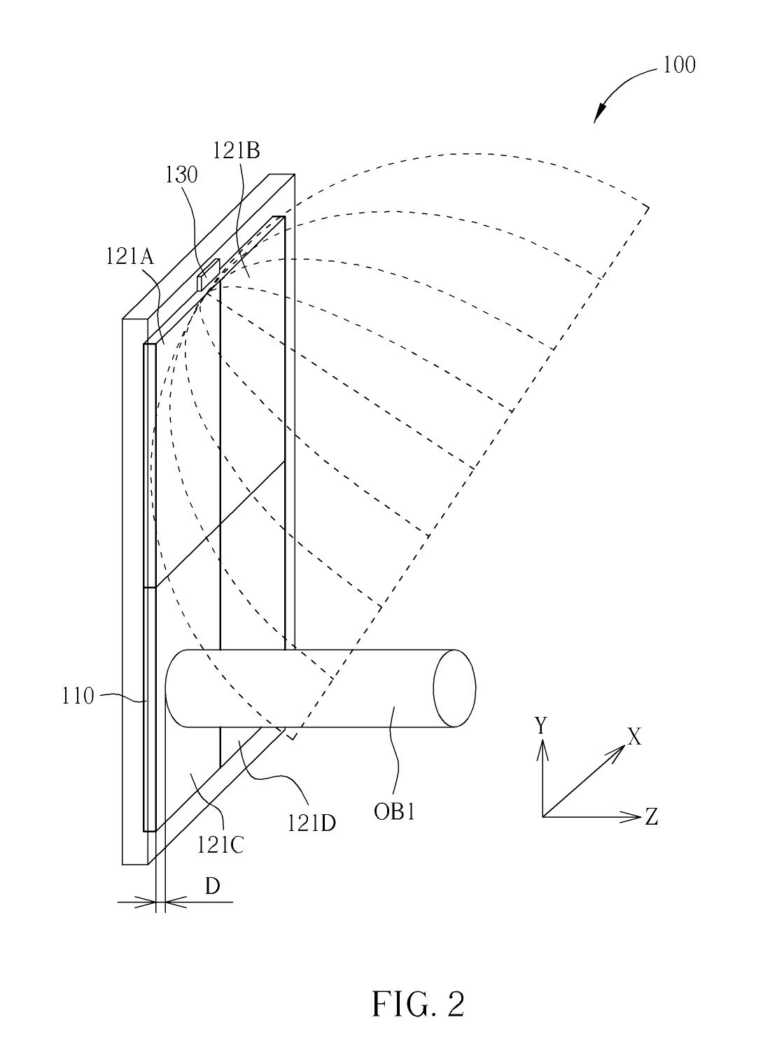

Please refer to FIG. 1 and FIG. 2. FIG. 1 is a schematic diagram illustrating a touch device according to the first exemplary embodiment of the present invention. FIG. 2 is a three-dimensional schematic diagram illustrating an operation of a touch device according to the first exemplary embodiment of the present invention. The drawings are schematic diagrams to help understanding the present invention, and the real scale can be adjusted, based on the design requirements. As shown in FIG. 1 and FIG. 2, in this exemplary embodiment, a touch device 100 having a touch sensing region 120 is provided. The touch device 100 includes a touch sensing structure 110 and an object detecting device 130. The touch sensing structure 110 is disposed in the touch sensing region 120 of the touch device 100. Furthermore, the touch sensing region 120 is divided into a plurality of sub sensing regions 121, and the touch sensing structure 110 includes a plurality of sensing units 111 to provide a function of positioning touch points. The object detecting device 130 is disposed outside the touch sensing region 120 of the touch device 100. Furthermore, the object detecting device 130 is employed to detect objects getting close to the touch device 100 and to determine which one of the sub sensing regions 121 is going to be touched by the object in order to enable the sensing units 111 within the sub sensing region 121 that is going to be touched by the object. The sensing units 111 include a plurality of first axis sensing units R and a plurality of second axis sensing units C, but not limited thereto. In other words, the object detecting device 130 is employed to detect objects getting close to the touch device 100 and to determine which one of the sub sensing regions 121 is going to be touched by the object in order to enable the first axis sensing units R and the second axis sensing units C within the sub sensing regions 121 that are going to be touched by the object.

In this exemplary embodiment, the touch sensing structure 110 preferably includes a capacitive touch sensing structure or an optical touch sensing structure, but not limited thereto. Moreover, the touch sensing structure 110 of this exemplary embodiment includes the first axis sensing units R1/R2/R3/R4/R5/R6 and the second axis sensing units C1/C2/C3/C4/C5/C6. Each of the first axis sensing units R extends along a first direction X, and each of the second axis sensing units C extends along a second direction Y. The first direction X is preferably perpendicular to the second direction Y, but not limited thereto. The first axis sensing units R and the second axis sensing units C are cross-disposed, so that when a touch event happens, the variations of the sensing signals of the first axis sensing units R and the second axis sensing units C are calculated to determine the position of the touch point. More specifically, when the touch sensing structure 110 is overall enabled, pulse driving signals are delivered to each of the first axis sensing units R sequentially, and sensing signals provided by each of the second axis sensing units C are collected to detect an electrical change such as the variations of capacitance of the touch point. The position of the touch point can therefore be further calculated and determined. In other words, the touch sensing structure 110 could be a matrix touch sensing structure, but not limited thereto. In this exemplary embodiment, the part of the touch sensing region 121 that is going to be touched is firstly determined by the object detecting device 130, and the touch sensing structure 110 is partially enabled. That is to say, in this exemplary embodiment, only the first axis sensing units R and the second axis sensing units C within the sub sensing region 121 that is going to be touched are enabled, and the sub sensing region 121 that is going to be touched is determined by the object detecting device 130. Accordingly, the frequency of turning on the first axis sensing units R and the second axis sensing units C can be reduced to decrease the power consumption. Additionally, the sensing method as illustrated could be regarded as a mutual capacitance sensing methods, but not limited thereto.

Furthermore, as shown in FIG. 1, the sub sensing regions 121 are arranged as a m*n matrix, m and n are respectively a natural number, and at least one of m and n is substantially larger than or equal to 2. In this exemplary embodiment, the touch sensing region 120 is divided into four sub sensing regions 121 including a sub sensing region 121A, a sub sensing region 121B, a sub sensing region 121C and a sub sensing region 121D, and the four sub sensing regions 121 are arranged as a 2*2 matrix. The number and the disposition of the sub sensing regions 121 of the touch sensing structure 110 are not limited, which could be adjusted based on the design demand. Additionally, each of the sub sensing regions 121 includes at least one region wherein at least one of the first axis sensing units R and at least one of the second axis sensing units C cross each other to provide each of the sub sensing regions 121 with a function of positioning touch points. Moreover, the object detecting device 130 may include an ultrasonic object detecting device or an image object detecting device or other proper apparatuses for detecting objects getting close to the touch device 100. The object detecting device 130 can be used to detect one or a plurality of objects getting close to the touch device 100.

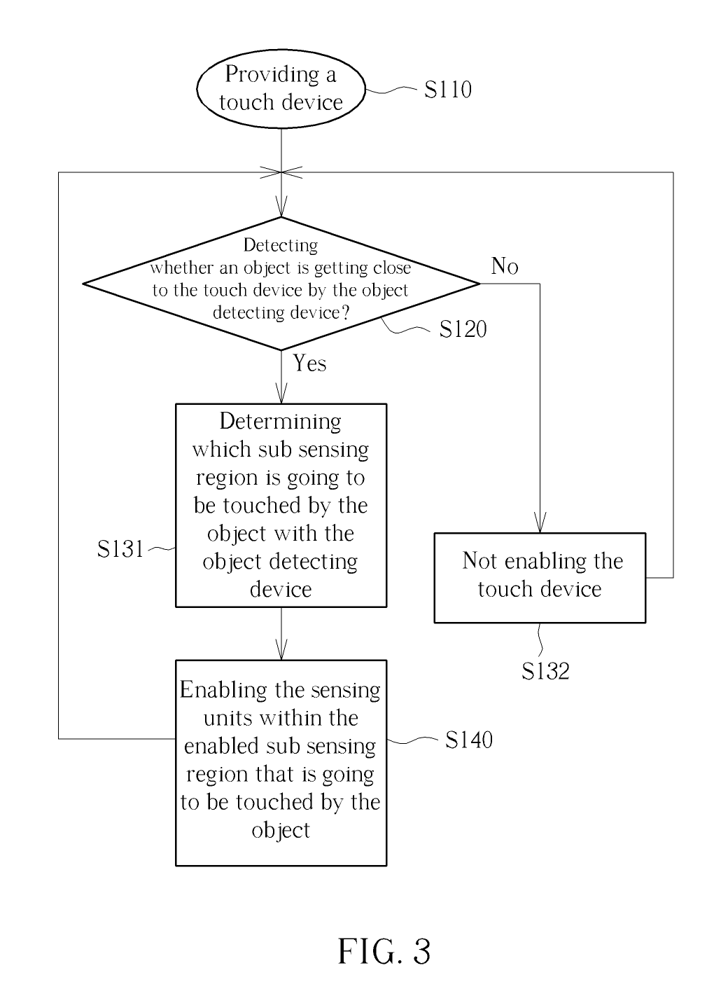

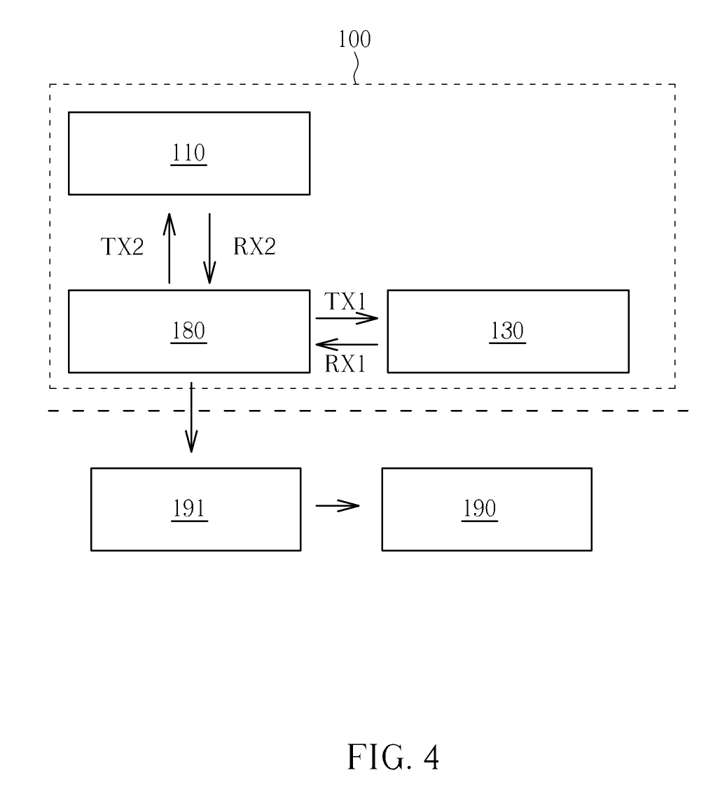

Please refer to FIG. 3 and FIG. 4, and refer to FIG. 1 and FIG. 2 together. FIG. 3 is a flow chart illustrating a touch sensing method of a touch device according to the first exemplary embodiment of the present invention. FIG. 4 is a schematic diagram illustrating the signal delivering pathway of a touch device according to the first exemplary embodiment of the present invention. As shown in FIG. 1 and FIG. 3, a touch sensing method of a touch device is provided in the present invention, and the touch sensing method includes the following steps. At first, the touch device 100 as illustrated above is provided, as shown in step S110. Subsequently, as shown in step S120, the object detecting device 130 is used to detected whether an object getting close to the touch device 100. If the detection result shows no object getting close to the touch device 100, step S132 would be performed, i.e. the touch device 100 would not be enabled. Conversely, if the detection result shows an object getting close to the touch device 100, step S131 would be performed, i.e. the sub sensing regions 121 that is going to be touched by the object is further enabled by the object detecting device 130. Then, step S140 is performed. According to the data about the enabled sub sensing region 121 by the object detecting device 130, the sensing units 111 within the enabled sub sensing region 121 which is going to be touched by the object are enabled. In other words, according to the data about the enabled sub sensing regions 121 by the object detecting device 130, the first axis sensing units R and the second axis sensing units C within the enabled sub sensing region 121 which is going to be touched by the object are enabled. For example, as shown in FIG. 1 and FIG. 2, as an object OB1 gets close to the touch device 100, the object detecting device 130 could determine that the sub sensing region 121C is going to be touched by the object OB1, accordingly, only the first axis sensing units R4/R5/R6 and the second axis sensing units C1/C2/C3 within the sub sensing region 121C are enabled, and other first axis sensing units R and other second axis sensing units C may not be enabled. Accordingly, the scanning frequency of the first axis sensing units R can be reduced for decreasing power consumption. Moreover, if the detection result of the object detecting device 130 shows no object getting close to the touch device 100, the touch sensing structure 110 could be in a mode of saving power in order to save the electricity consumption of the touch device 100.

As shown in FIG. 1, FIG. 2 and FIG. 4, the touch device 100 further includes a controller 180, and the controller 180 is respectively and electrically connected to the touch sensing structure 110 and the object detecting device 130. The controller 180 is used to divide the touch sensing region 120 into the sub sensing regions 121 and enabling the first axis sensing units R and the second axis sensing units C within each of the sub sensing regions 121. In other words, the controller 180 can be used to define the distribution status of the sub sensing regions 121. For example, the controller 180 could be used to divide the touch sensing region 120 into the sub sensing regions 121 arranged as a m*n matrix, wherein m and n are natural numbers, and at least one of the two among m and n is substantially larger than or equal to 2. In this exemplary embodiment, the controller 180 divides the touch sensing region 120 into four sub sensing regions 121 including the sub sensing region 121A, the sub sensing region 121B, the sub sensing region 121C and the sub sensing region 121D, i.e. the controller 180 divides the touch sensing region 120 into the sub sensing regions 121 arranged as a 2*2 matrix. The controller 180 is preferably a controller IC, but not limited thereto. The controller 180 could be used to deliver a detection driving signal TX1 to the object detecting device 130 to perform the object detection. Then, the object detecting device 130 may deliver back an object detecting signal RX1 to the controller 180, the controller 180 may further determine whether a touch driving signal TX2 should be delivered to the touch sensing structure 110 so as to partially enable the touch sensing structure 110. In other words, the controller 180 may be used to receive the object detecting signal RX1 from the object detecting device 130 and further enables the first axis sensing units R and the second axis sensing units C within one of the sub sensing regions 121. That is to say, the touch driving signal TX2 could be used to only enable the sensing units 111 within the sub sensing region 121 that the object OB1 gets close to, and other sensing units 111 would not be enabled. More specifically, the touch driving signal TX2 could be used to enable the first axis sensing units R4/R5/R6 and the second axis sensing units C1/C2/C3 within the sub sensing region 121C that the object OB1 gets close to, the variations in the sensing signals of the second axis sensing units C1/C2/C3 are used to determine the position of the touch point, and a touch sensing signal RX2 is delivered back to the controller 180 and a display controller 191 of a display panel 190 for displaying the result of the detection without turning other first axis sensing units R and other second axis sensing units C. In other words, the signals delivered back to the controller 180 for determining whether an object gets close to the touch device 100 could also be used to switch the display panel 190 to a display mode or keep the display panel 190 in a resting mode, which is beneficial for saving power consumption of the touch display panel.

It is appreciated that, in this exemplary embodiment, at first, the object detecting device 130 is employed to detect whether an object is getting close to the touch device 100 and to determined which one of the sub sensing regions 121 is going to be touched by the object. Subsequently, whether the touch sensing structure 110 should be enabled or not is determined, and how to partially enable the touch sensing structure 110 is calculated. Accordingly, the number of the first axis sensing units R and the second axis sensing units C enabled by the controller 180 can be reduced, and the scanning frequency of the first axis sensing units R can be reduced so as to decrease power consumption of the controller 180. Moreover, with such utilization of the touch sensing method of the touch device provided in the present invention, the report rate of the touch device 100 could be increased, thereby improving the performance of the touch device 100.

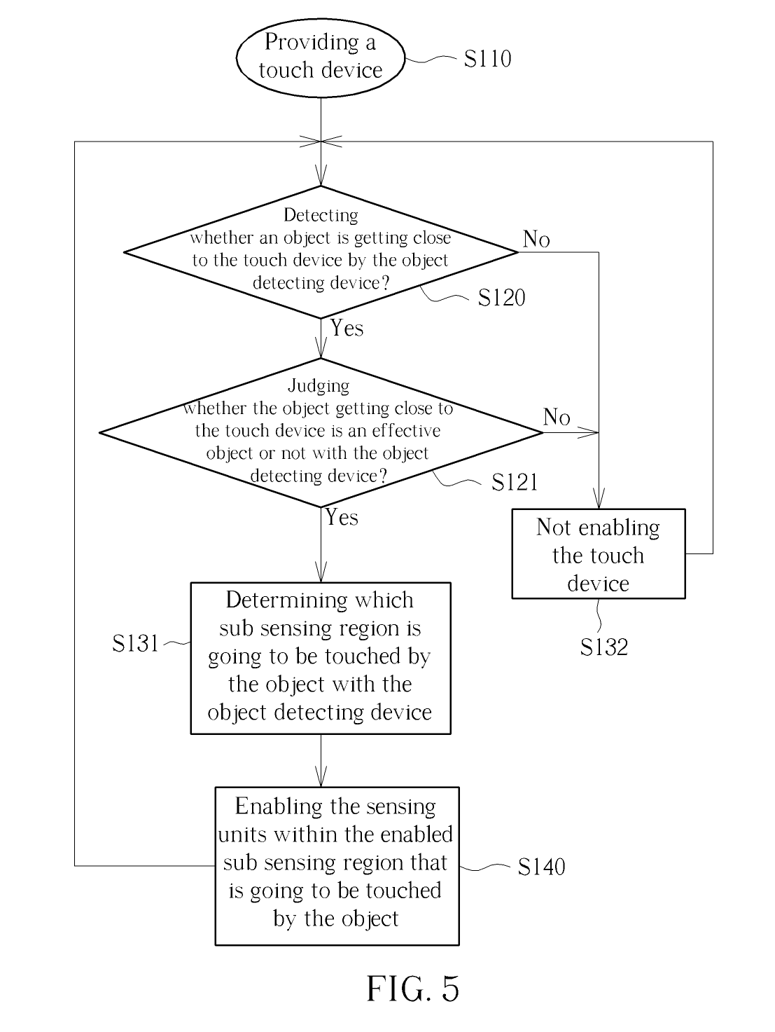

Please refer to FIG. 5, and refer to FIG. 2 together. FIG. 5 is a flow chart illustrating a touch sensing method of a touch device according to another exemplary embodiment of the present invention. As shown in FIG. 5, compared to the first exemplary embodiment as illustrated above, the touch sensing method further includes performing a step S121 before the step S131. During the step S121, whether the object OB1 getting close to the touch device 100 is an effective object or not is first judged by the object detecting device 130 to determine if the object detecting device 130 should be used to determine which sub sensing regions 121 is going to be touched by the object OB1. In other words, the use of the object detecting device 130 can dismiss non-effective objects such as wrists, elbows and other objects causing mis-touch, in order to prevent misjudgment and reduce unnecessary movements. The object detecting device 130 may be used to judge whether the object is a non-effective object or not by considering the area or the volume of the object OB1. For example, if the effective object OB1 is a touch pen having a predetermined area or volume, accordingly, as a new object such as a wrist gets close to the sub sensing regions 121, the detecting device 130 can detect that the area or volume of the new object is larger than the predetermined area or volume of the effective object OB1, and further assume that the new object is a non-effective object. The standard of judging effective objects could be adjusted by modifying the setting of the detecting device 130 according to various demands of touch applications. In this exemplary embodiment, the touch sensing method is similar to the touch sensing method illustrated in the first exemplary embodiment, except for the step S121, and the similarities including other steps and operation status are omitted herein for brevity.

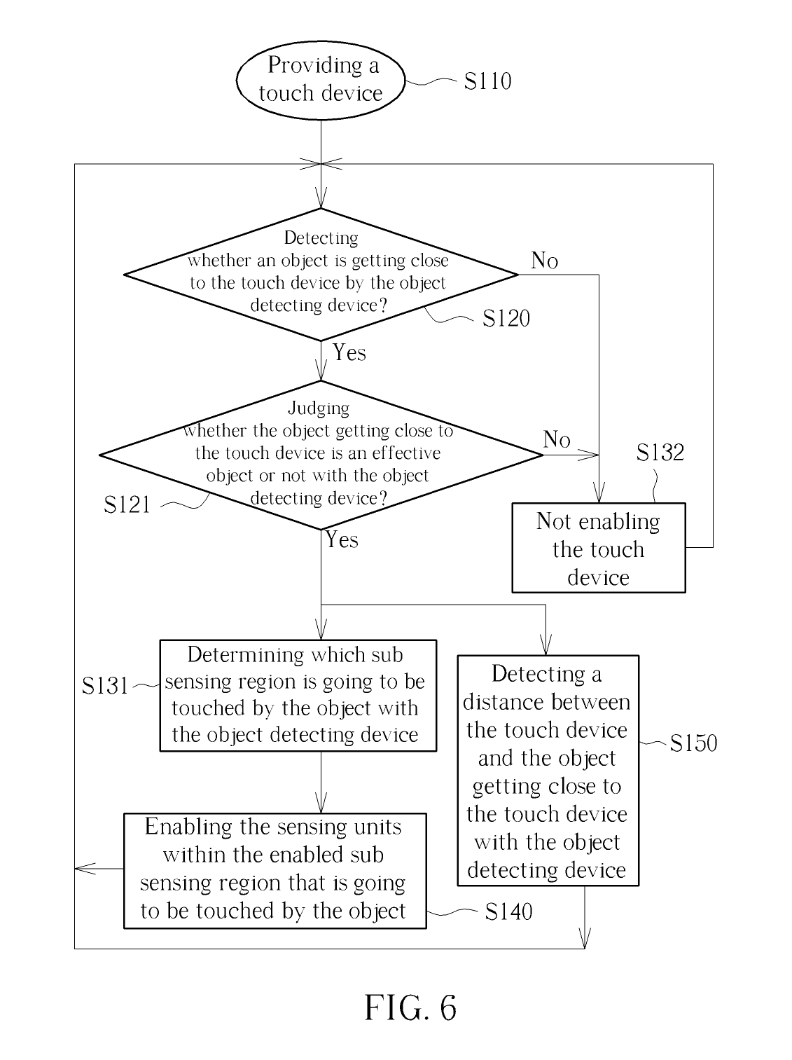

Please refer to FIG. 6, and refer to FIG. 1 and FIG. 2 together. FIG. 6 is a flow chart illustrating a touch sensing method of a touch device according to the other exemplary embodiment of the present invention. As shown in FIG. 6, compared to the exemplary embodiment as illustrated above, the touch sensing method further includes performing a step S150, and the step S150 is performed to detect a distance D between the touch device 100 and the object OB1 getting close to the touch device 100 by the object detecting device 130. In other words, in this exemplary embodiment, the object detecting device 130 can be used to judge the variation of the relative condition between the object OB1 and the touch device 100 along a third direction Z, accompanied with the original function of determining the planar position of the touch point along the first direction X and the second direction Y. The touch device 100 may have the function of determining a three-dimensional position of the touch point. In this exemplary embodiment, the touch sensing method is similar to the touch sensing method illustrated above, except for the step S150, and the similarities including other steps and operation status are omitted herein for brevity.

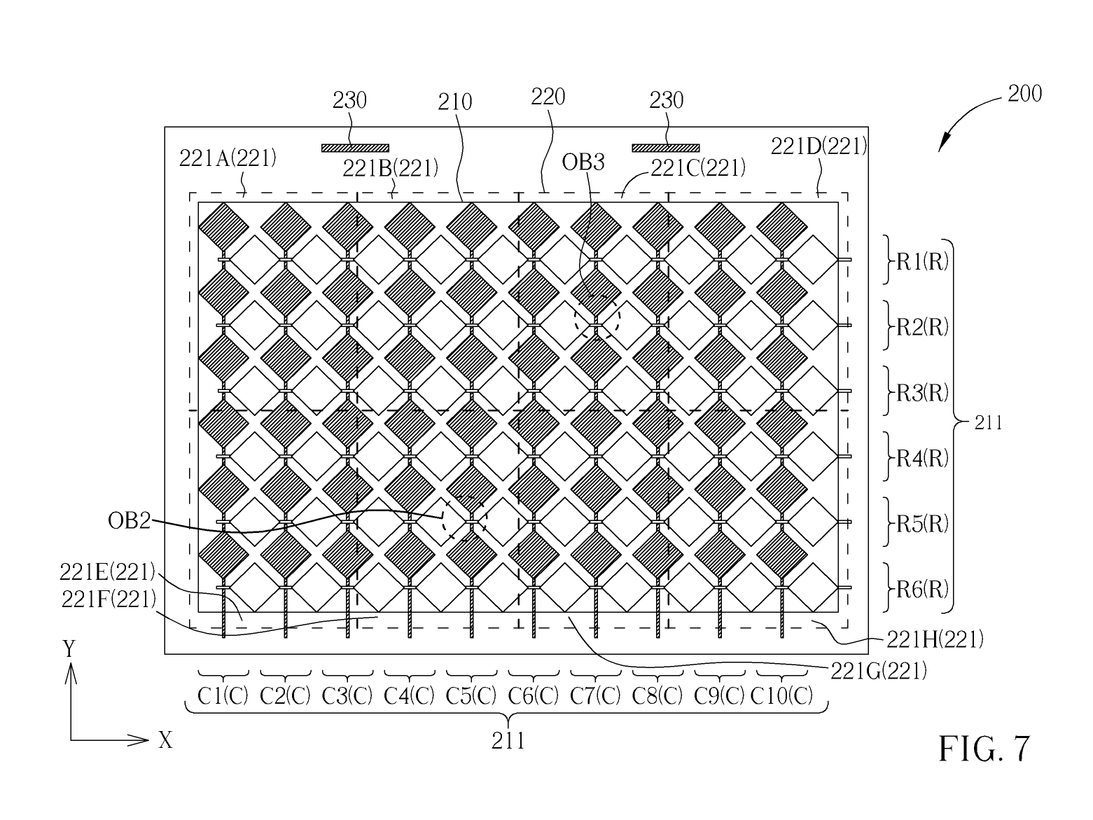

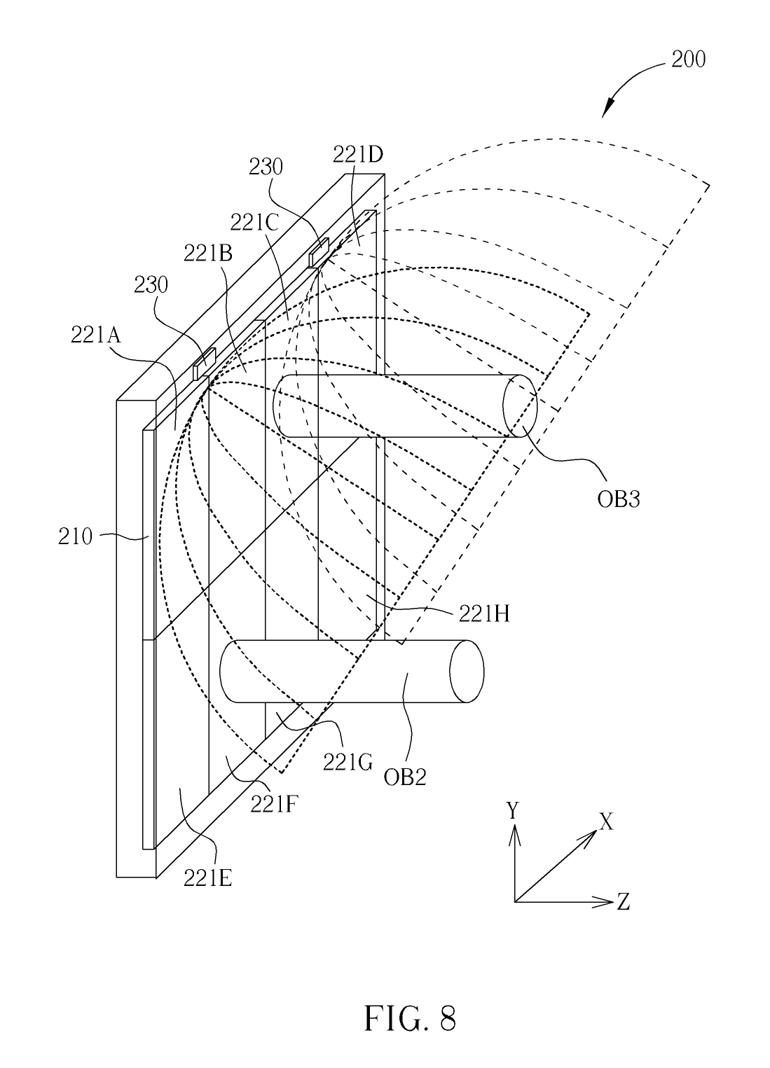

Please refer to FIG. 7 and FIG. 8. FIG. 7 is a schematic diagram illustrating a touch device according to the second exemplary embodiment of the present invention. FIG. 8 is a three-dimensional schematic diagram illustrating an operation of a touch device according to the second exemplary embodiment of the present invention. As shown in FIG. 7 and FIG. 8, a touch device 200 including a touch sensing structure 210 and two object detecting devices 230 is provided, and the touch sensing structure 210 is disposed in a touch sensing region 220 of the touch device 200. The touch sensing structure 210 includes a plurality of sensing units 221, and the sensing units 221 includes a plurality of first axis sensing units R1/R2/R3/R4/R5/R6 and a plurality of second axis sensing units C1/C2/C3/C4/C5/C6/C7/C8/C9/C10. The object detecting devices 230 are disposed outside the touch sensing region 220 of the touch device 200. The touch sensing region 220 is divided into sub sensing regions 221 including a sub sensing region 221A, a sub sensing region 221B, a sub sensing region 221C, a sub sensing region 221D a sub sensing region 221E, a sub sensing region 221F, a sub sensing region 221G and a sub sensing region 221H. It is appreciated that, in this exemplary embodiment, two object detecting devices 230 are disposed in the touch device 200 to increase the range and the precision of the detection, but not limited thereto. In the other exemplary embodiments, the type, the number and the disposition of object detecting devices could be adjusted according to the detection range of each of the object detecting devices and the size of the touch device in order to obtain proper object detection performances. As shown in FIG. 7 and FIG. 8, as an object OB2 and an object OB3 get close to the touch device 200, the object detecting device 230 could determine that the sub sensing region 221C and the sub sensing region 221F are going to be touched by the object OB2 and an object OB3 respectively, and only the first axis sensing units R1/R2/R3/R4/R5/R6 and the second axis sensing units C4/C5/C6/C7/C8 within the sub sensing region 221C and the sub sensing region 221F are enabled, while other second axis sensing units C may not be enabled. Accordingly, the power consumption could be reduced. The characteristics of each of the other components, the operation principle, and the touch sensing methods are similar to that of the first exemplary embodiment as illustrated above, except for the number of object detecting devices 230, the distribution status of sub sensing regions 220, and the total number of first axis sensing units and second axis sensing units. The similarities are therefore omitted herein for brevity. It is appreciated that, in the other exemplary embodiments, the number of sub sensing regions and the distribution status of sub sensing regions in the touch sensing region could be adjusted according to the size of the touch device, the touch resolution, the number and the detection range of each of the object detecting devices for obtaining proper touch sensing performance.

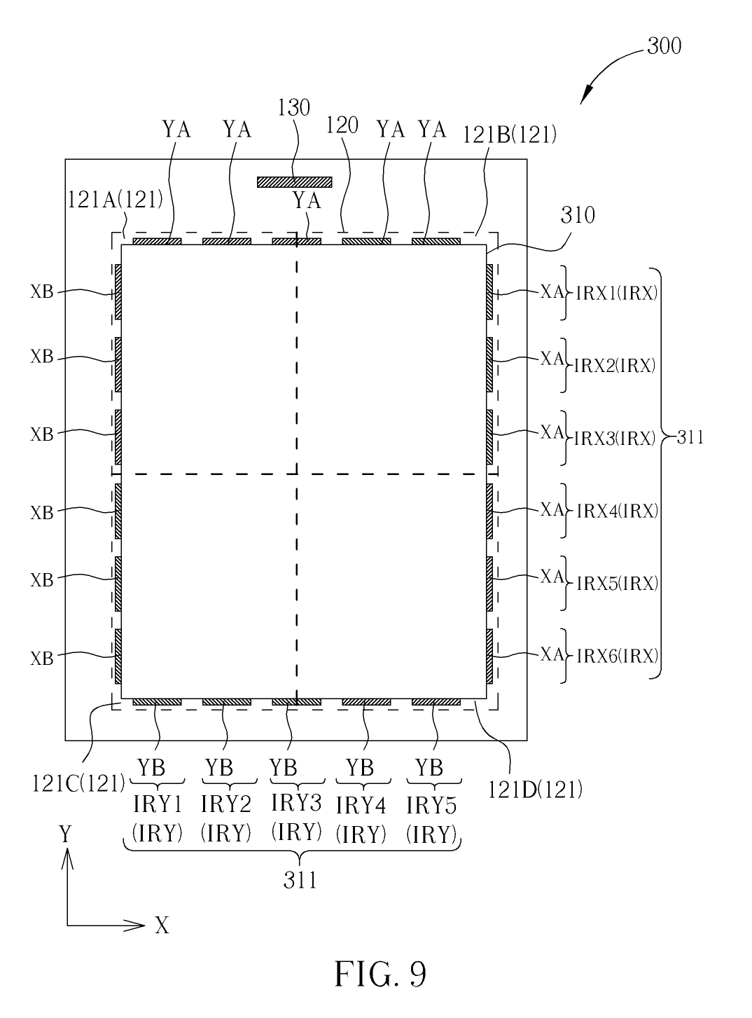

Please refer to FIG. 9. FIG. 9 is a schematic diagram illustrating a touch device according to the third exemplary embodiment of the present invention. As shown in FIG. 9, in this exemplary embodiment, a touch device 300 includes a touch sensing structure 310 and the object detecting device 130. The touch sensing structure 310 includes a plurality of sensing units 311, and the sensing units 311 includes a plurality of first axis sensing units IRX and a plurality of second axis sensing units IRY for providing a function of positioning touch points. More specifically, the touch sensing structure 310 includes the first axis sensing units IRX1/IRX2/IRX3/IRX4/IRX5/IRX6 and the second axis sensing units IRY1/IRY2/IRY3/IRY4/IRY5 disposed to cross each other. It is appreciated that each of the first axis sensing units IRX may include a transmitter XA and a receiver XB, and each of the second axis sensing units IRY may include a transmitter YA and a receiver YB. Each of the transmitters XA and each of the transmitters YA are respectively used to transmit light such as infrared light, and each of the receivers XB and each of the receivers YB are respectively used to receive light signals. Accordingly, as the touch device 300 is going to be touched, the change of the light signals caused by the touch points can be detected and the function of positioning touch points can be achieved. In other words, the touch sensing structure 310 may be an optical touch sensing structure, but not limited thereto. In this exemplary embodiment, the characteristics of each of the other components, the operation principle, and the touch sensing methods are similar to that of the first exemplary embodiment as illustrated above, except for the touch sensing structure 310 of the touch device 300, and the similarities are therefore omitted herein for brevity.

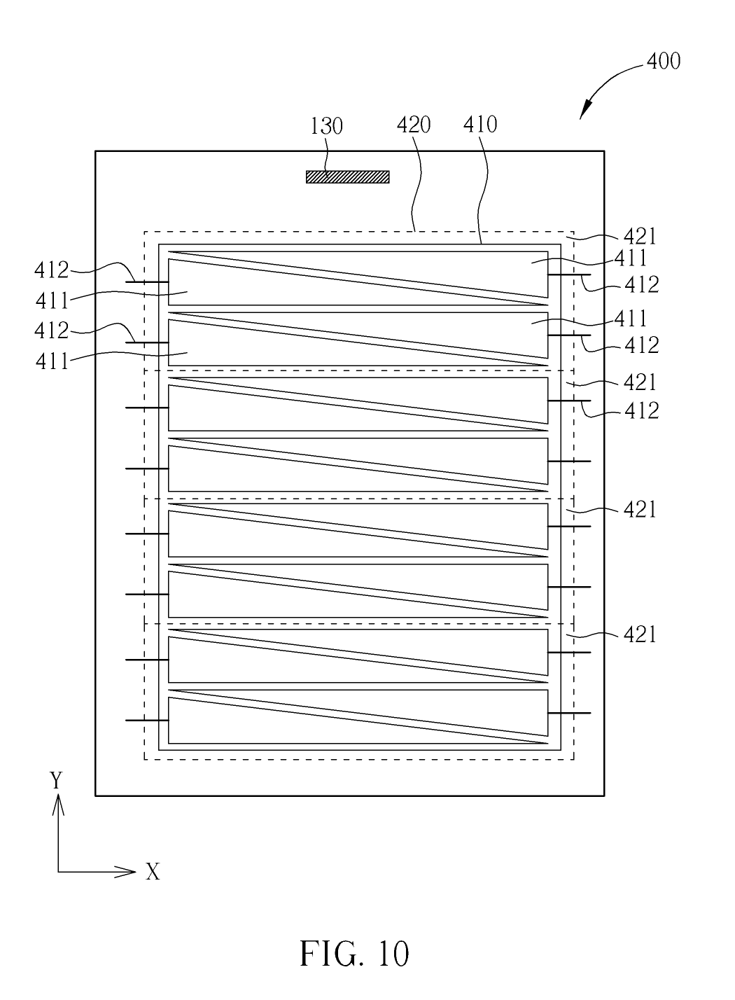

Please refer to FIG. 10. FIG. 10 is a schematic diagram illustrating a touch device according to the fourth exemplary embodiment of the present invention. As shown in FIG. 10, in this exemplary embodiment, a touch device 400 having a touch sensing region 420 includes a touch sensing structure 410 and the object detecting device 130. The touch sensing structure 410 is disposed in the touch sensing region 420 of the touch device 400. Furthermore, the touch sensing region 420 is divided into a plurality of sub sensing regions 421, and the touch sensing structure 410 includes a plurality of sensing units 411 for providing a function of positioning touch points. The touch device 400 of this exemplary embodiment different from the touch device 100 of the first exemplary embodiment includes the sensing units 411 which are preferably disposed uniformly in the touch sensing structure 410 and do not cross each other. The touch sensing structure 410 further includes a plurality of conducting lines 412 respectively connected to each of the sensing units 411, and each of the conducting lines 412 is used to deliver signals to each of the corresponding sensing units 411 in order to position the touch points. In the touch device 400 of this exemplary embodiment, only the sensing units 411 within the sub sensing region 421 that is selected according to the detection result of the object detecting device 130 are enabled without turning on the other sensing units 411. The touch sensing structure 410 could be enabled based on a self-capacitance sensing method preferably, but not limited thereto. Additionally, the shape of the sensing units 411 preferably includes a triangle shape, and the shape of sensing units 411 could be changed to other proper shapes according to the requirements. The sub sensing regions 421 are preferably disposed along the second direction Y in coordination with the sensing units 411, but not limited thereto. In the touch device 400 of this exemplary embodiment, the characteristics of each of the other components, the operation principle, and the touch sensing methods are similar to those of the first exemplary embodiment as illustrated above, except for the touch sensing structure 410 and the distribution status of the sub sensing regions 421, and the similarities are therefore omitted herein for brevity.

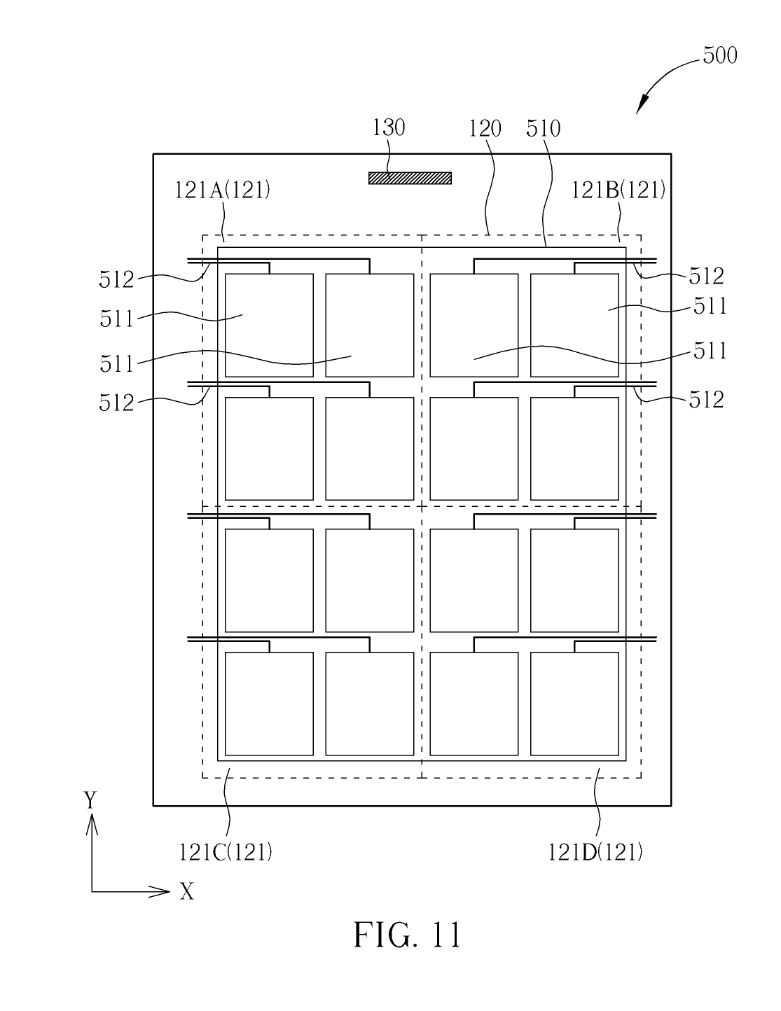

Please refer to FIG. 11. FIG. 11 is a schematic diagram illustrating a touch device according to the fifth exemplary embodiment of the present invention. As shown in FIG. 11, in this exemplary embodiment, a touch device 500 having the touch sensing region 120 includes a touch sensing structure 510 and the object detecting device 130. The touch sensing structure 510 is disposed in the touch sensing region 120 of the touch device 500, and the touch sensing region 120 is divided into a plurality of sub sensing regions 121. Furthermore, the touch sensing structure 510 includes a plurality of sensing units 511 for providing a function of positioning touch points. The touch device 500 of this exemplary embodiment different from the touch device 100 of the first exemplary embodiment includes the sensing units 511 which are preferably disposed uniformly in the touch sensing structure 510 and do not cross each other. The touch sensing structure 510 further includes a plurality of conducting lines 512 respectively connected to each of the sensing units 511, and each of the conducting lines 512 is used to deliver signals to each of the corresponding sensing units 511 in order to positioning the touch points. In the touch device 500 of this exemplary embodiment, only the sensing units 511 within the sub sensing region 121 that is selected according to the detection result of the object detecting device 130 are enabled without turning on the other sensing units 511. The touch sensing structure 510 could be enabled based on a self-capacitance sensing method preferably, but not limited thereto. Additionally, the shape of sensing units 511 preferably includes a rectangular shape, and the shape of sensing units 511 could be changed into other proper shapes according to the requirements. In the touch device 500 of this exemplary embodiment, the characteristics of each of the other components, the operation principle, and the touch sensing methods are similar to that of the fourth exemplary embodiment as illustrated above, except for the touch sensing structure 510, and the similarities are therefore omitted herein for brevity.

In conclusion, the touch device of the present invention includes an object detecting device used to detect whether external object gets close or touches the touch device, and determines whether the touch sensing structure in the touch sensing region should be enabled or not. Accordingly, when there is no object getting close to the touch device, the touch sensing structure could be maintained in an electricity saving mode. Furthermore, the object detecting device can also be used to determine which sub sensing region is going to be touched by the object so as to only partially enable the touch sensing structure. Consequently, the power consumption for driving the controller IC can be reduced and the report rate of the touch device can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch device having a touch sensing region, comprising:
a touch sensing structure disposed in the touch sensing region of the touch device, wherein the touch sensing region is divided into a plurality of sub sensing regions, and the touch sensing structure comprises a plurality of sensing units for providing a function of positioning touch points; and
at least one object detecting device, disposed outside the touch sensing region of the touch device, wherein the object detecting device is employed to detect whether an object is getting close to the touch device and to determine which sub sensing regions is going to be touched by the object so as to enable the sensing units within the sub sensing region that is going to be touched by the object.

2. The touch device according to claim 1, further comprising a controller respectively and electrically connected to the touch sensing structure and the object detecting device, wherein the controller is used to divide the touch sensing region into the sub sensing regions and receive an object detecting signal delivered from the object detecting device in order to enable the sensing units within one of the enabled sub sensing regions.

3. The touch device according to claim 1, wherein the sensing units comprises a plurality of first axis sensing units and a plurality of second axis sensing units.

4. The touch device according to claim 3, wherein the first axis sensing units and the second axis sensing units are cross-disposed, and each of the sub sensing regions comprises at least one region wherein at least one of the first axis sensing unit and at least one of the second axis sensing unit cross each other.

5. The touch device according to claim 1, wherein the touch sensing structure comprises a capacitive touch sensing structure or an optical touch sensing structure.

6. The touch device according to claim 1, wherein the object detecting device comprises a ultrasonic object detecting device or a image object detecting device.

7. The touch device according to claim 1, wherein the sub sensing regions are arranged as an m*n matrix, wherein m and n are natural numbers, and at least one among m and n is larger than or equal to 2.

8. A touch sensing method of a touch device, comprising:
providing a touch device as illustrated in claim 1;
detecting whether an object is getting close to the touch device by the object detecting device;
determining which sub sensing region is going to be touched by the object with the object detecting device; and
enabling the sensing units within the enabled sub sensing region that is going to be touched by the object.

9. The touch sensing method of the touch device according to claim 8, further comprising a step of judging whether the object getting close to the touch device is an effective object or not with the object detecting device, so as to determine if the object detecting device should be used to detect which sub sensing regions is going to be touched by the object.

10. The touch sensing method of the touch device according to claim 8, wherein the touch device further comprises a controller respectively electrically connected to the touch sensing structure and the object detecting device, the object detecting device delivers an object detecting signal to the controller, and the controller determines whether a touch driving signal should be delivered to the touch sensing structure.

11. The touch sensing method of the touch device according to claim 10, wherein the touch driving signal is used to enable the sensing units within the enabled sub sensing region that is going to be touched.

12. The touch sensing method of the touch device according to claim 10, further comprising delivering a touch sensing signal to a display controller of a display panel.

13. The touch sensing method of the touch device according to claim 8, further comprising detecting a distance between the touch device and the object getting close to the touch device with the object detecting device.
